(19) United States
(12) Patent Application Publication
(10) Pub. No.: US 2015/0072137 A1
(43) Pub. Date: Mar. 12, 2015

(54) GLASS SHEET WITH AN ENAMEL-BASED COATING

(71) Applicant: AGC Glass Europe, Louvain-La-Neuve (BE)

(72) Inventors: Christine Deneil, Ohey (BE); Ronny Pieters, Ganshoren (BE)

(73) Assignee: AGC Glass Europe, Louvain-La-Neuve (BE)

(21) Appl. No.: 14/382,973

(22) PCT Filed: Mar. 11, 2013
(86) PCT No.: PCT/EP2013/054899

§ 371 Date: Sep. 4, 2014

(30) Foreign Application Priority Data
Mar. 15, 2012 (EP) 12159655.5

(51) Int. Cl. C03C 17/00

(52) U.S. Cl. CPC C03C 17/007; C03C 17/009; C03C 2217/29; C03C 2217/475; C03C 2217/445
USPC 428/334; 428/428; 428/339

(57) ABSTRACT

The invention relates to a glass sheet having an enamel-based coating provided on at least one of its surface, which is in direct contact with said sheet and which comprises: a glass frit, inorganic pigments and organic compounds comprising at least one cross-linked compound, said coating exhibiting a xylene resistance of at least 00double rubs, as measured using the Solvent Resistance Rub Test according to ASTM D5402-06 (2011) as modified therein. Such a glass sheet can be heat treated (for example, in view of a subsequent tempering process) and, before heat treatment, can be handled and transported without damaging the coating, can be cut and ground without causing the coating to peel off or to be damaged at the borders of the cutting line, and offer a good resistance under running water, avoiding the peeling off or destruction of the coating during edges grinding or storage or transportation.

### 1. FIELD OF THE INVENTION

The present invention relates to a coated glass sheet, in particular a glass sheet covered by an enamel-based coating. The glass sheet of the invention is temperable, i.e. it can be thermally treated with a view in particular to being subsequently tempered, and it can be handled before its thermal treatment without deterioration.

Glass sheets according to the present invention can have various applications. For example, they can be used for decorative purposes for furniture, wardrobes, partitions, tables, shelves, in bathrooms, as wall covering, in outside locations, as spandrels. They can also be used for automotive glazing, e.g. for windscreens. More and more of these applications require sheets of tempered glass since such sheets have the advantage of being more resistant to rupture and to breaking.

### 2. SOLUTIONS OF THE PRIOR ART

Numerous types of glass sheets covered with an enamel-based coating are already known in the art. In particular, enameled glass sheets that can be tempered are also known.

In a known process, a glass sheet is covered with a layer of organic paint that is then dried and/or cured in an oven, for example, at about 150° C. for about 10 minutes. When such sheets covered with a totally organic paint layer are treated at high temperature, the paint burns and it is therefore damaged or even completely destroyed. These conventional painted sheets could therefore not generally survive at temperatures higher than 200° C. without deterioration. Moreover, when the glass sheet is tempered before being painted, this requires that the glass sheet already has its final dimensions, as it is not possible to cut a tempered glass sheet. Unfortunately, this does not allow continuous mass production, on large surfaces.

The product Colorbel®, a tempered glazing with one of its faces covered with a vitrified coloured enamel, should also be cited as an example. Such a product is temperable. Nevertheless, before tempering and/or vitrification (or sintering) of the enamel, the coating of this product does not have sufficient mechanical resistance to enable it to withstand being transported, handled, and/or stored. It is therefore necessary for this product that tempering is conducted practically immediately after production and preferably on the same production line, which constitutes a severe limitation from an industrial viewpoint.

Consequently, different products have been developed to enable these disadvantages to be resolved.

In particular, the International Application WO2007/135192 A1 describes a glass sheet that is covered with, in sequence, a first layer comprising an enamel and a second layer comprising a resin. Such a glass sheet can be handled and transported before its thermal treatment without damaging the coating, and it can be cut and ground before the thermal treatment without causing the coating to lift off or causing damage to the boundary of the cutting line. In general, the second layer is present temporarily (sacrificial layer) to give the painted glass sheet some mechanical resistance before the thermal treatment: it is thus intended to be removed after the thermal treatment or destroyed during this treatment. Nevertheless, although this two-layer system can provide a good mechanical resistance to scratches before thermal treatment, we have noticed that during production the resistance of the first layer, before the second layer is deposited, can be low and that handling equipment such as roller conveyors or suction caps can damage the first layer before it is protected by the second layer, resulting in defects in the final product.

Painted glass sheets comprising an enamel layer containing organic materials to between 11% and 40% have recently been developed (WO2011/051459 A1). Such a content of organic material in the enamel layer provides advantageous mechanical resistance properties before thermal treatment. Such glass sheets can be handled and transported before the thermal treatment without damaging the coating, e.g. without creating scratches. They can be cut and ground before the thermal treatment without causing the coating to lift off or causing damage to the boundary of the cutting line. Moreover, they can also provide a good resistance to running water avoiding the phenomenon of peeling. In addition, these properties can be obtained with a single layer, which can be easier, less costly and less time-consuming than the known process that requires two layers.

### 3. OBJECTIVES OF THE INVENTION

The objective of the invention in particular is to remedy the precited disadvantages resolving the technical problem, i.e. to provide a glass sheet covered with an enamel-based coating that is able to undergo a thermal treatment, in particular with a view to it being subsequently tempered.

Another objective of the invention in at least one of its embodiments is to provide a glass sheet covered with an enamel-based coating that before its thermal treatment has an increased mechanical resistance compared to the glass sheets of the prior art. More specifically, an objective of the invention in at least one of its embodiments is to provide a glass sheet covered with an enamel-based coating and that can withstand transport and handling before its thermal treatment.

Finally, another objective of the invention is to provide a solution to the disadvantages to the prior art that is simple, quick and economical. More specifically, such an objective aims to provide a glass sheet covered with an enamel-based coating that is able to undergo a thermal treatment, has an increased mechanical resistance before its thermal treatment and can be obtained in a single step (or by means of a single layer).

### 4. OUTLINE OF THE INVENTION

The invention relates to a glass sheet having an enamel-based coating provided on at least one surface of said sheet, which is in direct contact with said sheet and which comprises:
a glass frit,
inorganic pigments, and
organic compounds comprising at least one cross-linked compound.

Moreover, the enamel-based coating of the invention exhibits a xylene resistance of at least 100 double rubs, as measured using the Solvent Resistance Rub Test according to ASTM D5402-06 (2011) as modified therein.

Hence, the invention rests on a completely novel and inventive approach, since it enables a solution to be found for the disadvantages of glass products of the prior art and the posed technical problem to be resolved. In fact, the inventors have demonstrated that it was possible, with such high values of “double rubs” measured by standard ASTM D5402, to obtain a glass sheet covered with an enamel-based coating that is able to undergo a thermal treatment, has an increased mechanical resistance before its thermal treatment and can be obtained by means of a single layer. Moreover, such a glass sheet allows reaching mechanical resistance that is improved compared to glass sheet according to WO2011/051459 A1 prior art. This result is surprising in that a particularly high number of double rubs (translating the chemical resistance of an organic coating to a specific solvent) can be related to a high mechanical resistance of said coating.

Other features and advantages of the invention will be made clearer from reading the following description of preferred embodiments given by way of simple illustrative and non-restrictive examples.

The invention relates to a glass sheet. The glass according to the invention can belong to various categories. The glass can be a soda-lime glass, a boron glass, a lead glass, a glass containing one or more additives distributed uniformly within its structure, such as e.g. at least one inorganic colouring agent, an oxidising compound, a viscosity-regulating agent and/or a melting agent. The glass of the invention is preferably a soda-lime glass. The glass of the invention can be a float glass, a drawn glass or a patterned glass. It can be clear, extra-clear, coloured in the bulk, sanded and/or frosted. The term “soda-lime glass” is used here in its broad sense and relates to any glass that contains the following base components (expressed in percentages by total weight of the glass):

| | |
|---|---|
| SiO₂ | 60 to 75% |
| Na₂O | 10 to 20% |
| CaO | 0 to 16% |
| K₂O | 0 to 10% |
| MgO | 0 to 10% |
| Al₂O₃ | 0 to 5% |
| BaO | 0 to 2% |
| BaO + CaO + MgO | 10 to 20% |
| K₂O + Na₂O | 10 to 20%. |

According to an embodiment, the glass sheet is a sheet of float glass. The glass sheet is preferably a sheet of soda-lime float glass. Still according to this embodiment, the sheet of float glass of the invention can have a thickness varying e.g. from 1.8 to 10.2 mm.

The glass sheet according to the invention can be larger than 1 m×1 m in size. It can be of the size known by the term “PLF” (e.g. 3.21 m×6 m or 3.21 m×5.50 m or 3.21 m×5.10 m 3.21 m×4.50 m) or the size known by the term “DLF” (e.g. 3.21 m×2.55 m or 3.21 m×2.25 m).

The enamel-based coating of the invention comprises:
a glass frit,
inorganic pigments, and
organic compounds comprising at least one cross-linked compound.

A liquid enamel composition generally comprises initially (i.e. before applying on a substrate) a powder formed from inorganic pigments and a glass frit (vitreous matrix) in suspension in a medium often comprising solvent(s). The term “enamel” in the invention (thus coated on the glass sheet) is used here for an enamel that is cured but not yet sintered. “Curing” is understood to mean here a step which allows a liquid paint, lacquer or enamel-based coating to harden and it involves drying (solvent evaporation) and cross-linking by means of reaction of polymer chains. The invention thus covers an enamel-based coating after curing, meaning after drying (i.e. after the solvent(s) present in the initial composition has (have) been eliminated) and cross-linking.

The organic compounds in the enamel-based coating of the invention can comprise at least one compound selected from the following: polyols, alkyds, acrylics, polyacrylics, polyacrylates, polymethacrylates, acrylamides, melamine, aldehydes derivatives, polycarbonates, stryrenes, vinyl acrylics, urethanes, polyurethanes, polyesters, polyolefins, urethane alkyds, polyurea, amino resins, polyamides, epoxides, epoxy esters, phenolic resins, silicone resins, PVC, PVB, aqueous resins and reaction products of the aforementioned compounds.

The organic compounds in the enamel-based coating of the invention can also advantageously comprise one or several additives to paints such as a dispersing agent, a flow agent, an anti-foam, an anti-UV agent, a catalyst, a wetting agent, an adhesion promoter, a matting agent and/or structuring agent.

The at least one cross-linked compound according to the invention can be selected from the following: polyols, alkyds, acrylics, polyacrylics, polyacrylates, polymethacrylates, acrylamides, melamine, aldehydes derivatives, polycarbonates, stryrenes, vinyl acrylics, urethanes, polyurethanes, polyesters, polyolefins, urethane alkyds, polyurea, amino resins, polyamides, epoxides, epoxy esters, phenolic resins, silicone resins, PVC, PVB, aqueous resins and reaction products of the aforementioned compounds.

According to the invention, the enamel-based coating exhibits a xylene resistance of at least 100 double rubs, as measured using the Solvent Resistance Rub Test according to ASTM D5402-06 (2011) as modified therein.

The solvent resistance of the coating of the invention or its number of double rubs is measured by a wet rub test using xylene as solvent. The ASTM standard D5402-06 (Reapproved 2011) is used but modified/adapted as follows: An automatic equipment is used to perform this test consistently and reliably with the added benefit of greatly reducing operator contact with and exposure to the solvent used for procedure. A cotton cloth (CODE 1323 supplied by SDC Enterprises Limited) is saturated with xylene and rapidly placed on a flat circular Teflon head (less than 10 seconds). The coated side of the glass sheet is then double rubbed with the Teflon head bearing the soaked cotton cloth with a constant, built-in load of 3600 g, on a distance of 10 cm. The soaked cotton cloth will damage the coating after a certain number of double rubs (or cycles), depending on the resistance of the coating to the solvent. During the whole duration of the test, the cotton should be kept wet/soaked with xylene. The operator should take care that a film of solvent is always present around the rubbing head during operation. When the cotton seems to be damaged, it should be immediately replaced by a new one. The speed should be adjusted between 45 and 55 full oscillations (back and forth double rubs) per minute. The test is completed when the operator sees partially or completely the glass surface, with an appropriate color-contrasted background applied on the glass side, opposite to the initially coated side. The result of the test is defined as the number of double rubs (or cycles) needed to make the background visible from the initially coated side. All double rub data given in the present specification are an average of three test results.

According to the invention, a “double rub” is thus intended to mean, according to the ASTM D5402-06, the act of rubbing a xylene soaked cloth in one complete forward and back motion over the coated surface of the glass sheet.

According to the invention, the “xylene resistance” corresponds to the number of double rubs that the coating can withstand without seeing at least partially the glass surface.

Preferably, the enamel-based coating exhibits a xylene resistance of at least 150 double rubs. Such a higher minimum value of double rubs gives a higher mechanical resistance to the coating before thermal treatment.

According to an embodiment of the invention, the enamel-based coating comprises between 11 and 40% of organic compounds, expressed in weight percentage. Such a content of organic materials in the enamel-based coating of the invention enables a very appreciable mechanical resistance to be obtained for said coating before it is tempered. The organic material can come from the initial medium of a commercial enamel, into which organic compounds are added for the purpose of obtaining the desired quantity of organic compounds in the coating. Alternatively, the enamel liquid composition can be prepared by mixing, amongst others, a glass frit, inorganic pigments and organic compounds that play the role in particular of medium to obtain an enamel coating with the desired quantity of organic compounds.

The enamel-based coating preferably contains no more than 30% by weight of organic compounds and more preferred no more than 25% by weight of organic compounds. As a result of such a higher limit the phenomenon referred to as “Stardust” to be avoided that can be observed by transmitting light onto a painted glass can be avoided. It appears when a layer of paint is not completely homogeneous and has some (microscopic) holes. These holes allow the light to pass through the coating and thus be visible when viewed from the glass side showing small points of light.

To measure the content of organic compounds according to the invention, a quantity of the coating (generally in the order of 1 to 2 grams) has been removed from the surface of the glass sheet after being dried (devoid of residual solvents) and cross-linked and analysed by thermogravimetric analysis (TGA). The analysis is conducted in air from 20° C. to 1000° C. with a temperature increase of 10° C./min. The content of organic compounds is determined on the basis of the residue as soon as no further weight loss is observed. In general, the organic material is completely burned in the region of 400-500° C.

After curing, the coating preferably has a softening temperature of at least 20° C., preferably at least 25°, 30°, 35° or 40° C. These values can help to provide even more advantageous mechanical resistance properties before thermal treatment. This softening temperature can be equal to the Tg value (glass transition temperature) in the case where the organic compounds are essentially composed of polymers or of the melting point if other compounds are present.

According to an embodiment, the enamel-based coating extends continuously over substantially the entire surface of the glass sheet. Over substantially the entire surface of the glass sheet is understood to mean over at least 90% of said surface. The enamel-based coating preferably extends continuously over at least 95% of the surface. According to an alternative embodiment, the enamel-based coating partially covers the surface of the glass sheet.

According to the invention, once cured, but before its thermal treatment, the enamel-based coating has a thickness in the range of between 10 and 200 microns. Once cured, but before its thermal treatment, the enamel-based coating preferably has a thickness in the range of between 20 and 100 microns. Coating thickness is understood to mean the average geometric thickness here. If the thickness of the coating is too low, this can cause an enameled glass sheet that does not have the desired mechanical resistance properties or aesthetics to be obtained; if it is too high, the curing cannot be complete and separations/deteriorations in the coating can occur. Such thicknesses can be obtained by one or more applications during the production process.

According to the invention, the enamel-based coating is in direct contact with the glass sheet. The glass sheet can however be chemically treated prior to be coated by the enamel-based coating, without departing from the invention. For example, to further improve the adhesion of the coating to the glass sheet, the surface of said glass sheet can be treated with an adhesion promoter, which can thus be found between the glass sheet and said coating. The adhesion promoter can contain silane, for example.

According to certain embodiments, the glass sheet having an enamel-based coating can comprise additional coatings, coated above the enamel coating, further from the glass sheet. This can help further increase the mechanical resistance of the final painted glass sheet. Such an additional coating can be of the same type as the second layer described in patent application WO2007/104752 A1.

According to the invention, the enamel-based coating can be opaque or translucent. Opaque is understood to mean that the light transmission of the glass sheet is lower than 5%. The enamel-based coating is also preferably coloured (including white and black). If the glass sheet is thermally treated, the colour can change during treatment, depending on the composition of said coating. If this occurs, it is possible to take this into account and adapt the liquid enamel composition so that the colour of the enameled glass sheet after its thermal treatment is the desired colour.

Different methods known per se can be suitable for depositing the liquid enamel composition onto the glass sheet. For example, it is possible to deposit the liquid enamel composition by a curtain coating process (onto a moving glass sheet), by a bar coater process, by a roller coating process, by a flow processor, by a spraying process. Screen printing can also be used, in particular when only some portions of the glass sheet must be covered.

After the step of depositing the liquid enamel composition, the composition is cured, i.e. dried and cross-linked. This step allows the enamel composition, comprising at least one cross-linkable compound, to harden and adhere to the glass sheet thus forming the enamel-based coating according to the invention. Cross-linking of the liquid composition can be implemented by the temperature, by UV, IR or NIR rays, by electron beams and/or by induction heating. At this stage, the enamel is not molten (or sintered) yet. For example, if a cross-linking step by IR radiation is considered, this step is preferably conducted at a temperature of at least 150° C. and/or not exceeding 300° C., for 1 to 20 minutes in a static oven or for 5 to 10 minutes in an industrial oven. The temperature at the surface of the glass will preferably not exceed 250° C.

In general, the glass sheet according to the invention can undergo a thermal treatment (or heat treatment), in particular it can be temperable, i.e. it can be thermally treated with a view to being subsequently tempered. Thermal treatment is understood to mean a treatment at temperatures that are not lower than 500° C. For example, such thermal treatment can involve heating or exposing the glass sheet covered by the coating to a temperature greater than about 560° C. When the glass sheet according to the invention is thermally treated, the glass frit in the enamel-based coating sinters and the organic compounds burns. The drying and cross-linking step therefore does not constitute a thermal treatment in the sense of the invention. The invention therefore covers a glass sheet that has not been thermally treated, but that is heat-treatable.

The glass sheet according to the invention, once tempered, can be used as safety glass in buildings in accordance with standard EN12150-1:2000.

The glass sheet according to the present invention, which has been cured but not yet thermally treated, can advantageously exhibit very appreciable properties in terms of adhesion of the coating to the glass, chemical durability, mechanical resistance, similar to those of conventional painted glass sheets that are not capable of being tempered. In particular, a glass sheet according to the invention can have one or more of the following properties:

| | |
|---|---|
| Abrasion test (1000 revolutions) | 20% at most of the coating is removed, |
| | preferably 18% at most. |
| Clemen test (according to | No visible scratching on the coating side |
| standard ISO 1518-1992) | at 700 g, preferably at 800 g, more |
| | preferred at 1000 g. |
| Persoz test (according to | At least 170s, preferably at least 180s. |
| standard ISO 1522-1998) | |
| UV test (according to standard | No change in colour (ΔE* <2) |
| ASTM G53-88, without water | after 1000 h-300 W |
| at 60° C. by continuous UVA | |
| irradiation at 340 nm) | |
| Condensation test (according to | No deterioration of the coating |
| standard DIN 50 017/40° C./ | No change in colour (AE* <2) |
| 98% relative humidity/20 days) | |

The UV and condensation tests are all described in details in application WO2007/104752 A1. The Persoz test allows measuring the coating hardness: The samples are conditioned at a temperature of 20° C. during at least 24 hours prior to the measurement. The Persoz test is based on the principle that the amplitude of the pendulum's oscillation will decrease more quickly when supported on a softer surface. The Persoz test measures the time for the amplitude to decrease from 12° to 4°. Full details of this test are set out in International Standard ISO 1522-1998.

Glass sheets according to the invention can have varied applications. These sheets can be used, for example, for decorative applications, single- or double-sided, decorative purposes for furniture, wardrobes, partitions, tables, shelves, in bathrooms, as wall covering, in outside locations such as spandrels. They can also be used for automotive applications such as windscreens, e.g. if the enamel-based coating is applied around the periphery of the glass sheet.

Embodiments of the invention will now be further described, by way of examples only, together with some comparative examples, not in accordance with the invention. Table I summarizes all examples and comparative examples. The following examples are provided for illustrative purposes, and are not intended to limit the scope of this invention.

### EXAMPLES

### Examples 1-5

### According to the Invention

A 4 mm-thick sheet of clear float glass was firstly washed in a normal manner. It is then passed under a bar coater where it is covered with a enamel-based composition. It is then cured by temperature under conditions mentioned in Table I. Thickness of the coating, once cured and before heat treatment, is also given in Table I.

The enamel-based coating composition deposited on the glass sheet is for each examples 1-5, an enamel −50 to 75 Wt %—consisting in glass frit and pigments to which 25 to 50 Wt % of a commercial paint (Clearcoat from the company FENZI) is added and thoroughly mixed to the enamel in order to increase the content of reactive organic material in the medium. The Clearcoat, comprises methacrylic resin, melamine resin and epoxy resin. Thus, the medium is enriched in cross-linkable compounds ie reactive organic compounds. By “Reactive organic compound”, it is understood to mean an organic material which will form cross-linked polymer chains in enamel-based coating during the curing.

The samples according to the invention show numbers of double rubs above 100, varying between 103 and above 300. These values are extremely high compared to those obtained for comparative examples 8-10 (commercial enamels) but also significantly higher than the values obtained for comparative examples 11-13 (examples according to WO2011/051459 A1).

The samples according to the invention, after curing but before thermal treatment, show good Persoz results (above 200 s.—see Table I), which illustrates their good hardness. Moreover, the products have resisted to a heat treatment (180 seconds at 680° C.) and are thus heat-treatable.

### Comparative Examples 6-7

A 4 mm-thick sheet of clear float glass was transported on a belt conveyor. It is firstly washed in a normal manner. It is then passed under a bar coater applicator where it is covered with a liquid enamel composition. The composition deposited on the glass sheet is, for each examples 6-7, an enamel −92 and 95 Wt %-consisting in glass frit and pigments to which 5 and 8 Wt % of a commercial paint (Clearcoat from the company FENZI) is added directly to the enamel. The organic content in cured coating is below 11 Wt %.

Comparative examples 6-7 show numbers of double rubs below 100, varying between 26 and 76. These values are significantly weak compared to those obtained for comparative examples 1-5 (enamels according to the invention)

### Comparative Examples 8-10

A 4 mm-thick sheet of clear float glass was transported on a belt conveyor. It is firstly washed in a normal manner. It then passes under a bar coater applicator where it is covered with a liquid enamel composition. The composition deposited on the glass sheet is, for each examples 8-10, chosen from commercial liquid enamel. The enamels used in examples 8-10 are identified in Table I. The coated glass sheet is then cured by temperature under conditions mentioned in Table I. Thickness of the coating, once cured and before heat treatment, is also given in Table I.

Comparative examples 8-10 show numbers of double rubs varying between 2 and 3.

Mechanical resistance of the coating before heat treatment is very low: Persoz results are poor. Moreover, their resistance under running water is not acceptable, edge working is not possible, and unacceptable scratches appear during handling and/or transportation before heat treatment.

### Comparative Examples 11-13

A 4 mm-thick sheet of clear float glass was transported on a belt conveyor. It is firstly washed in a normal manner. It is then passed under a curtain applicator where it is covered with a liquid enamel composition. The composition deposited on the glass sheet is, for each examples 11-13, a commercial liquid enamel to which a commercial paint (Clearcoat from the company FENZI) is added to provide the enamel with an increased content of organic material, according to the application WO2011/051459 A1. The clearcoat comprises methacrylic resin, melamine resin and epoxy resin.

The coated glass sheet is then cured at temperatures under conditions mentioned in Table I. Amount of paint added to increase organic content and thickness of the coating, once cured and before heat treatment, are also given in Table I.

Comparative examples 11-13 show numbers of double rubs varying between 18 and 46.

TABLE I

| | | | | | | | after curing and | |
|---|---|---|---|---|---|---|---|---|
| | Coating composition | | | | | | before heat treatment | |
| | | | | organic | Coating | | | Rubs |
| | | | Added | content | thickness | curing | Persoz | (nb of |
| Ex. | Enamel | | clearcoat | [Wt %] | [μm] | conditions | [sec.] | cycles) |
| 1 | 75% | *black | 25% | 14.6 | 51 | 10 min, | 227 | 141 |
| | | | | | | 190° C. | | |
| 2 | 75% | *black | 25% | 14.6 | 65 | 10 min, | 220 | 300 |
| | | | | | | 190° C. | | |
| 3 | 50% | *black | 50% | 36.7 | 30 | 10 min, | 228 | 103 |
| | | | | | | 190° C. | | |
| 4 | 50% | *black | 50% | 36.7 | 52 | 10 min, | 230 | >300 |
| | | | | | | 190° C. | | |
| 5 | 75% | **white | 25% | 16.7 | 54 | 10 min, | 231 | 123 |
| | | | | | | 190° C. | | |
| 6 | 95% | *black | 5% | 7.4 | 56 | 10 min, | 174 | 26 |
| | | | | | | 190° C. | | |
| 7 | 92% | **white | 8% | 10.5 | 65 | 10 min, | 177 | 76 |
| | | | | | | 190° C. | | |
| 8 | 100% | white | — | 9.3 | 50 | 10 min, | 163 | 2 |
| | | | | | | 190° C. | | |
| 9 | 100% | black | — | 4.9 | 68 | 10 min, | 148 | 2 |
| | | | | | | 190° C. | | |
| 10 | 100% | black | — | 5.3 | 72 | 10 min, | 120 | 3 |
| | | | | | | 190° C. | | |
| 11 | 90% | white | 10% | 11.7 | 66 | 10 min, | 182 | 18 |
| | | | | | | 190° C. | | |
| 12 | 90% | grey | 10% | 11.9 | 57 | 10 min, | 187 | 27 |
| | | | | | | 190° C. | | |
| 13 | 75% | white | 25% | 16.6 | 57 | 10 min, | 196 | 46 |
| | | | | | | 190° C. | | |

white enamel = enamel TEMPVER Bianco 3400-147A from the company FENZI
black enamel = enamel TEMPVER Nero 3302-BETA928 A from the company FENZI
grey enamel = enamel TEMPVER Grigio 3400-7077 A from the company FENZI
clearcoat = glassorex clearcoat from company Fenzi
*only glass frit and pigment from enamel TEMPVER Nero 3302-BETA928 A from the company FENZI
**only glass frit and pigment from enamel TEMPVER Bianco 3400-147A from the company FENZI

1. A glass sheet comprising an enamel-based coating on at least one surface of the glass sheet,
wherein
the coating is in direct contact with the glass sheet,
the coating comprises:
a glass frit,
inorganic pigments, and
organic compounds comprising a cross-linked compound, and
the coating exhibits a xylene resistance of at least 100 double rubs, as measured using the Solvent Resistance Rub Test according to ASTM D5402-06 (2011) as modified therein.

2. The glass sheet according to claim 1, wherein the coating comprises between 11 and 40% of the organic compounds, expressed in weight percentage.

3. The glass sheet according to claim 1, wherein the coating comprises between 11 and 25% of the organic compounds, expressed in weight percentage.

4. The glass sheet according to claim 1, wherein the coating exhibits a xylene resistance of at least 150 double rubs.

5. The glass sheet according to claim 2, wherein the coating has a softening temperature of at least 20° C.

6. The glass sheet according to claim 1, wherein the organic compounds comprises at least one compound selected from the group consisting of: a polyol, an alkyd, an acrylic, a polyacrylic, a polyacrylate, a polymethacrylate, an acrylamide, melamine, an aldehyde derivative, a polycarbonate, styrene, a vinyl acrylic, a urethane, a polyurethane, a polyester, a polyolefin, a urethane alkyd, polyurea, an amino resin, a polyamide, an epoxide, an epoxy ester, a phenolic resin, a silicone resin, PVC, PVB, an aqueous resin and a reaction product thereof.

7. The glass sheet according to claim 1, wherein the cross-linked compound is selected from the group consisting of: a polyol, an alkyd, an acrylic, a polyacrylic, a polyacrylate, a polymethacrylate, an acrylamide, melamine, an aldehyde derivative, a polycarbonate, styrene, a vinyl acrylic, a urethane, a polyurethane, a polyester, a polyolefin, a urethane alkyd, a polyurea, an amino resin, a polyamide, an epoxide, an epoxy ester, a phenolic resin, a silicone resin, PVC, PVB, an aqueous resin and a reaction product thereof.

8. The glass sheet according to claim 1, wherein the coating has a thickness of from 10 to 200 μm.

9. The glass sheet according to claim 1, wherein the coating has a thickness of from 15 to 100 μm.

10. The glass sheet according to claim 1, wherein the coating extends continuously over substantially the entire surface of the glass sheet.

11. The glass sheet according to claim 1, wherein the glass sheet comprises an additional coating, which is coated above the enamel-based coating and further from the glass sheet.

12. The glass sheet according to claim 1, wherein the glass sheet is heat treatable.
